(19) United States
(12) Patent Application Publication
(10) Pub. No.: US 2014/0195974 A1
(43) Pub. Date: Jul. 10, 2014

(54) METHOD AND APPARATUS FOR USING A FINGER SWIPE INTERFACE TO CONTROL A SYSTEM

(71) Applicant: IDENTITY VALIDATION PRODUCTS, LLC, Daingerfield, TX (US)

(72) Inventors: CLAUDIO R. BALLARD, FORT LAUDERDALE, FL (US); SANDY FLIDERMAN, ALBERTSON, NY (US)

(21) Appl. No.: 14/014,339

(22) Filed: Aug. 29, 2013

Related U.S. Application Data
(60) Provisional application No. 61/694,760, filed on Aug. 29, 2012.

(51) Int. Cl. G06F 3/0484; G06F 3/0488; G06F 3/0482; G06F 3/0481

(52) U.S. Cl. CPC G06F 3/0484; G06F 3/04817; G06F 3/0488; G06F 3/0482
USPC 715/825; 715/835

(57) ABSTRACT

A method for using a finger swipe interface to control the functionality of a system comprises the following steps: storing a key swipe pattern; storing a key indicia; sensing a pick swipe pattern using a finger swipe interface; comparing the pick swipe pattern to the key swipe pattern; storing a positive result if the pick pattern is the key pattern; displaying, an array of different indicia at a plurality of discrete display locations. If a positive result, the array of indicia includes the key indicia, whereas if a negative result, the array does not include the key indicia. A pick indicia is sensed and compared to the key indicia. The system in controlled in a first manner if the pick indicia is the key indicia; and controlled in a second manner if the pick indicia is not the key indicia.

### CROSS-REFERENCE TO RELATED APPLICATIONS

This application claims benefit of U.S. Provisional Application No. 61/694,760, filed Aug. 29, 2012, entitled METHOD AND APPARATUS FOR ADVANCED FINGER SWIPE INTERFACE (Atty. Dkt. No. VMVM-31433), the specification of which is incorporated herein by reference in its entirety.

### TECHNICAL FIELD

The following disclosure relates to methods and apparatus for controlling the functionality of a system implemented in a computing device, for example a computer, smart phone or tablet computer. More specifically, it relates to a method and apparatus for using a finger swipe interface to control a system. The finger swipe interface may include a touch screen device or other system capable of responding to the movement of a human finger.

### BACKGROUND

So-called “finger swipe” interfaces are known for use in security systems for accessing touch-screen devices such as smart phones and tablets. In a finger swipe interface, the user uses a finger (or other pointing device, e.g., a stylus) to trace a continuous path (i.e., a “swipe pattern”) across the screen between an array of known target spots. If the swipe pattern traced by the user matches a pre-determined pattern (i.e., a “key pattern”), then access to the device (or to a program or app) protected by the finger swipe system is granted. If the swipe pattern traced by the user does not match the key pattern, then access is denied.

One problem with conventional finger swipe interfaces is that a visible path may form on the touch screen where the swipe path has been repeatedly traced. This visibility may be due to wear on the actual screen (or screen protector) and/or due to body oils or other contaminants deposited on the screen during “swiping.” Although seeing the visible path does not precisely disclose the swipe pattern (because the starting point and order of swiping may not be apparent), the visible path greatly reduces the effort necessary for an unauthorized person to recreate a swipe pattern that matches the key pattern and gain access to the device. A need therefore exists, for a finger-swipe interface that is resistant to unauthorized use even if the swipe pattern leaves a visible path on the screen.

### SUMMARY

In one embodiment, there is provided an advanced method for finger swipe interface for the purposes of expedited log-in to a computer, tablet, handheld device or mobile phone. This invention utilizes a variable number of “touch points” on touch screen of any computer, tablet, handheld device or mobile phone in conjunction with a user-defined swipe pattern and color selection sequence in lieu of conventional user name and password methods widely used for access to said devices. Allowing for a user to select a color of the identified touch points and the number of touch points creates an exponentially more secure identifier for user log-ins to these devices. Historically, previous embodiments utilize a static number of touch points (usually 9) which means the variations are limited to a relative and determinable size. Adding a color selection choice for the touch point and allowing the user to increase the number of touch points to swipe on the screen makes for a dynamic sequence that is extraordinarily more complex and secure while expediting conventional login processes that engage full alpha and/or numeric keyboard strokes.

In one aspect of the invention, a method executable on a computing device for using a finger swipe interface to control the functionality of a system implemented on the computing device is provided, where the computing device includes a processor, a memory operatively connected to the processor and a display device operatively connected to the processor. The finger swipe interface is operatively connected to the computing device and capable of sensing an ordered sequence of M spatial movements performed by a specified object between a preselected set of P spatial points in proximity to the finger swipe interface. The method comprises: (a) storing, in a memory of a computing device, a key swipe pattern including a set of M_{K} ordered movements to be executed between a set of P_{K} spatial points; (b) storing, in the memory of the computing device, a key secondary indicia, the key secondary indicia being selected from a set of S different available secondary indicia; (c) initializing the finger swipe cycle by setting value N=1; (d) sensing, using a finger swipe interface operatively connected to the computing device, a pick(N) swipe pattern including a set of M_{N} ordered movements executed in real time between a set of P_{N} spatial points by a specified object in proximity to the finger swipe interface; (e) transferring the pick(N) swipe pattern from the finger swipe interface to the computing device and storing the pick(N) swipe pattern in the memory of the computing device using a processor operatively connected to the memory; (f) displaying, on a display device operatively connected to the processor and having a plurality of discrete display locations, an array(N) of S_{N} different secondary indicia selected from the set of S available secondary indicia, wherein each secondary indicia of the array(N) of S_{N} secondary indicia is disposed in a different respective discrete display location of the plurality of discrete display locations, wherein the selection of which particular secondary indicia of the array(N) is to be located in each respective discrete display location is performed using one of a random or pseudo-random selection, and wherein the array(N) of S_{N} secondary indicia includes the key secondary indicia, and a set(N) of (S_{N}−1) different non-key secondary indicia selected from the S available secondary indicia; (g) sensing, using the processor, a pick(N) secondary indicia selected in real time from the array(N) of S_{N} secondary indicia displayed on the display device; (h) storing the pick(N) secondary indicia in the memory of the computing device; (i) comparing, using the processor, the pick(N) swipe pattern stored in the memory to the key swipe pattern stored in the memory; (j) comparing, using the processor, the pick(N) secondary indicia stored in the memory to the key secondary indicia stored in the memory; and (k) controlling, using the processor, a system implemented on the computing device to function in a first manner if both the pick(N) swipe pattern is the key swipe pattern, and the pick(N) secondary indicia is the key secondary indicia; and (L) controlling, using the processor, the system implemented on the computing device to function in a second manner if either the pick(N) swipe pattern is not the key swipe pattern, or the pick(N) secondary indicia is a non-key secondary indicia.

In another embodiment, when either (i) the pick(N) swipe pattern is not the key swipe pattern, or (ii) the pick(N) secondary indicia is a non-key secondary indicia, then the method further comprises: incrementing the value of N to (N+1), provided N does not exceed a predetermined maximum value; and repeating steps (d)-(L).

In another embodiment, S_{N}=S, such that the key secondary indicia and all non-key secondary indicia are displayed in the array(N) of secondary indicia in each finger swipe cycle.

In another embodiment, S_{N}<S and the step of displaying an array(N) further comprises: populating the array(N) with the key secondary indicia and (S−S_{N}−1) different non-key secondary indicia; and wherein the non-key secondary indicia in the array(N) are selected from the set of available secondary indicia using one of a random or pseudo-random selection; whereby a different selection of non-key secondary indicia is displayed in each finger swipe cycle.

In another embodiment, S_{N}<S_{(N+1)}<S_{(N+2)}, whereby the number of non-key secondary indicia displayed on the display device increases in successive finger swipe cycles.

In another embodiment, the array(N) of S_{N} secondary indicia is displayed in a different portion of the display device in successive finger swipe cycles.

In another embodiment, the step of storing a key swipe pattern further includes: specifying, using the processor of the computing device, the value of M_{K} that is the number of ordered movements included in the key swipe pattern; specifying, using the processor of the computing device, the value of P_{K} that is the number of spatial points included in the key swipe pattern; and sensing in real time, using the finger swipe device operatively connected to the computing device, an ordered sequence of M_{K} movements between the P_{K} spatial points.

In another embodiment, the set of S different available secondary indicia includes at least one of: a set of S different colors; a set of S different geometric shapes; or a set of S different alphabetic letters.

In another embodiment, the finger swipe interface includes a touch screen device operatively connected to the computing device and the specified object is one of a human finger and a screen stylus moving in contact with the touch screen device.

In another embodiment, the finger swipe interface includes a camera system operatively connected to the computing device and the specific object is one of a human finger or human limb moving non-contact spatial proximity to the camera.

In another aspect of the invention, a method executable on a computing device for using a finger swipe interface to control the functionality of a system implemented on the computing device is provided, where the computing device includes a processor, a memory operatively connected to the processor and a display device operatively connected to the processor. The finger swipe interface is operatively connected to the computing device and capable of sensing an ordered sequence of M spatial movements performed by a specified object between a preselected set of P spatial points in proximity to the finger swipe interface. The method comprises: (a) storing, in a memory of a computing device, a key swipe pattern including a set of M_{K} ordered movements to be executed between a set of P_{K} spatial points; (b) storing, in the memory of the computing device, a key secondary indicia, the key secondary indicia being selected from a set of S different available secondary indicia; (c) initializing the finger swipe cycle by setting value N=1; (d) sensing, using a finger swipe interface operatively connected to the computing device, a pick(N) swipe pattern including a set of M_{N} ordered movements executed in real time between a set of P_{N} spatial points by a specified object in proximity to the finger swipe interface; (e) transferring the pick(N) swipe pattern from the finger swipe interface to the computing device and storing the pick(N) swipe pattern in the memory of the computing device using a processor operatively connected to the memory; (f) comparing, using the processor, the pick(N) swipe pattern stored in the memory to the key swipe pattern stored in the memory; (g) storing, in the memory, a “positive” swipe(N) result if the pick(N) swipe pattern is the key swipe pattern and storing, in the memory, a “negative” swipe(N) result if the pick(N) swipe pattern is not the key swipe pattern; (h) retrieving the swipe(N) result from the memory and displaying, on a display device operatively connected to the processor and having a plurality of discrete display locations, an array(N) of S_{N} different secondary indicia selected from the set of S available secondary indicia, wherein each secondary indicia of the array(N) of S_{N} secondary indicia is disposed in a different respective discrete display location of the plurality of discrete display locations, wherein the selection of which particular secondary indicia of the array(N) is to be located in each respective discrete display location is performed using one of a random or pseudo-random selection, and wherein if the “positive” swipe(N) result is retrieved from the memory, the array(N) of S_{N} secondary indicia includes the key secondary indicia, and a set(N) of (S_{N}−1) different non-key secondary indicia selected from the S available secondary indicia, and wherein if a “negative” swipe(N) result is retrieved from the memory, the array(N) of S_{N} secondary indicia includes a set(N) of S_{N} different non-key secondary indicia selected from the S available secondary indicia; (i) sensing, using the processor, a pick(N) secondary indicia selected in real time from the array(N) of S_{N} secondary indicia displayed on the display device; (j) storing the pick(N) secondary indicia in the memory of the computing device; (k) comparing, using the processor, the pick(N) secondary indicia stored in the memory to the key secondary indicia stored in the memory; and (L) controlling, using the processor, a system implemented on the computing device to function in a first manner if the pick(N) secondary indicia is the key secondary indicia; and (m) controlling, using the processor, the system implemented on the computing device to function in a second manner if the pick(N) secondary indicia is a non-key secondary indicia.

In another embodiment, when the pick(N) secondary indicia is a non-key secondary indicia, then the method further comprises: incrementing the value of N to (N+1), provided N does not exceed a predetermined maximum value; and repeating steps (d)-(m).

In another embodiment S_{N}<S and the non-key secondary indicia included in the array(N) for each finger swipe cycle are selected from the set of available secondary indicia using one of a random or pseudo-random selection; whereby a different selection of non-key secondary indicia is displayed in each finger swipe cycle.

In another embodiment, S_{N}<S_{(N+1)}<S_{(N+2)}, whereby the number of non-key secondary indicia displayed on the display device increases in successive finger swipe cycles.

In another embodiment, S_{(N+1)}=(2×S_{N}) and S_{(N+2)}=(3×S_{N}).

In another embodiment, further comprising the steps of controlling, using the processor, when the maximum predetermined value for N is exceeded, a system implemented on the computing device to function in a “lockdown” mode.

In another aspect of the invention, a computing device for controlling the functionality of a system implemented on the computing device using a finger swipe interface is provided. The computing device comprises: a processor; a memory operatively connected to the processor; a display device operatively connected to the processor; a finger swipe interface operatively connected to the processor and capable of sensing an ordered sequence of M spatial movements performed by a specified object between a preselected set of P spatial points in proximity to the finger swipe interface; executable code stored in the memory of the computing device for storing, in the memory of the computing device, a key swipe pattern including a set of M_{K} ordered movements to be executed between a set of P_{K} spatial points; executable code stored in the memory of the computing device for storing, in the memory of the computing device, a key secondary indicia, the key secondary indicia being selected from a set of S different available secondary indicia; executable code stored in the memory of the computing device for initializing the finger swipe cycle by setting value N=1; executable code stored in the memory of the computing device for sensing, using the finger swipe interface operatively connected to the computing device, a pick(N) swipe pattern including a set of M_{N} ordered movements executed in real time between a set of P_{N} spatial points by a specified object in proximity to the finger swipe interface; executable code stored in the memory of the computing device for transferring the pick(N) swipe pattern from the finger swipe interface to the computing device and storing the pick(N) swipe pattern in the memory of the computing device using the processor; executable code stored in the memory of the computing device for comparing, using the processor, the pick(N) swipe pattern stored in the memory to the key swipe pattern stored in the memory; executable code stored in the memory of the computing device for storing, in the memory, a “positive” swipe(N) result if the pick(N) swipe pattern is the key swipe pattern and storing, in the memory, a “negative” swipe(N) result if the pick(N) swipe pattern is not the key swipe pattern; executable code stored in the memory of the computing device for retrieving the swipe(N) result from the memory and displaying, on a display device operatively connected to the processor and having a plurality of discrete display locations, an array(N) of S_{N} different secondary indicia selected from the set of S available secondary indicia, wherein each secondary indicia of the array(N) of S_{N} secondary indicia is disposed in a different respective discrete display location of the plurality of discrete display locations, wherein the selection of which particular secondary indicia of the array(N) is to be located in each respective discrete display location is performed using one of a random or pseudo-random selection, and wherein if the “positive” swipe(N) result is retrieved from the memory, the array(N) of S_{N} secondary indicia includes the key secondary indicia, and a set(N) of (S_{N}−1) different non-key secondary indicia selected from the S available secondary indicia, and wherein if a “negative” swipe(N) result is retrieved from the memory, the array(N) of S_{N} secondary indicia includes a set(N) of S_{N} different non-key secondary indicia selected from the S available secondary indicia; executable code stored in the memory of the computing device for sensing, using the processor, a pick(N) secondary indicia selected in real time from the array(N) of S_{N} secondary indicia displayed on the display device; executable code stored in the memory of the computing device for storing the pick(N) secondary indicia in the memory of the computing device; executable code stored in the memory of the computing device for comparing, using the processor, the pick(N) secondary indicia stored in the memory to the key secondary indicia stored in the memory; and executable code stored in the memory of the computing device for controlling, using the processor, a system implemented on the computing device to function in a first manner if the pick(N) secondary indicia is the key secondary indicia; and executable code stored in the memory of the computing device for controlling, using the processor, the system implemented on the computing device to function in a second manner if the pick(N) secondary indicia is a non-key secondary indicia.

In another embodiment, the finger swipe interface includes a touch screen device operatively connected to the processor and the display device is a display screen operatively connected to the processor.

In another embodiment, the secondary indicia are at least one of: a set of S different colored areas on the display screen; a set of S different geometric shapes on the display screen; or a set of S different alphabetic letters on the display screen.

In another embodiment, the finger swipe interface includes a camera system operatively connected to the computing device and the specific object is one of a human finger or human limb moving non-contact spatial proximity to the camera.

### BRIEF DESCRIPTION OF THE DRAWINGS

For a more complete understanding, reference is now made to the following description taken in conjunction with the accompanying Drawings in which:

FIG. 1 is a view of a mobile device screen illustrating a finger-swipe interface in accordance with one embodiment;

FIG. 2 is a schematic diagram of an exemplary computing device executing a method for using a finger swipe interface to control a system in accordance with another embodiment;

FIG. 3A-3F are views of a computing device similar to the device of FIG. 2 executing a method for using a finger swipe interface in accordance with additional embodiments, wherein

FIG. 3A shows a first initialization screen in accordance with one embodiment of the method;

FIG. 3B shows a second initialization screen of the embodiment of FIG. 3A wherein the key swipe pattern is entered;

FIG. 3C shows a first screen of a first authentication attempt;

FIG. 3D shows a second screen of the first authentication attempt;

FIG. 3E shows a second screen of a second authentication attempt in accordance with another embodiment; and

FIG. 3F shows a second screen of a second authentication attempt in accordance with yet another embodiment.

### DETAILED DESCRIPTION

Referring now to the drawings, wherein like reference numbers are used herein to designate like elements throughout, the various views and embodiments of method and apparatus for using a finger swipe interface to control a system are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

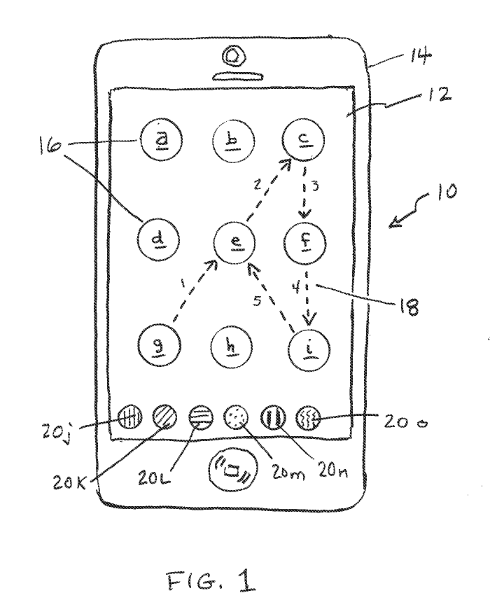

Referring now to FIG. 1, there is illustrated a touch screen 12 of a mobile device 14 upon which is implemented an advanced finger swipe interface 10 in accordance with one embodiment. The mobile device 12 may be any type of touch-screen device including, but not limited to, a computer, tablet, handheld device or mobile phone. Displayed on the touch screen 12 are a plurality of “touch points” 16. In the embodiment shown, nine touch points 16 are shown; however, in other embodiments the number of touch points may be variable and selected by the user. In the embodiment shown, the nine touch points 16 are arranged in a 3×3 rectangular pattern; however, in other embodiments the arrangement of touch points may be variable (e.g., rectangular, triangular, circular, etc.), and selected by the user. For purposes of illustration, the touch points 16 in FIG. 1 are labeled “a” through “i”; however, these labels will not be present in most implementations of the system. Further, in the illustrated embodiment, the touch points 16 are visible; however, in other embodiments, the touch points may be only defined areas of the touch screen that are not visible.

A user-defined swipe pattern 18 is shown connecting selected touch points 16. The swipe pattern 18 comprises a set of M ordered movements executed between a set of P spatial points. In the illustrated embodiment, the spatial points are the touch points 16, and the swipe pattern 18 is the ordered movement between touch points g-e-c-f-i-e. In other words, the number of spatial points, P, =9, the number of ordered movements, M, =5, and the set of ordered movements comprising the swipe pattern 18 is as follows: movement 1 from 16g to 16e; movement 2 from 16e to 16c, movement 3 from 16c to 16f; movement 4 from 16f to 16i; and movement 5 from 16i to 16e. It will be appreciated that the number of spatial points, P, and/or the number of ordered movements, M, in the swipe pattern may vary from one embodiment to the other. In some embodiments, the number of spatial points, P, and/or the number of ordered movements, M, in the swipe pattern may be specified by the user, whereas in other embodiments, P and/or M may be fixed. As previously explained, in some embodiments the swipe pattern 18 may become visible during execution as a visible path; however, in other embodiments the swipe pattern is not visible.

Referring still to FIG. 1, the finger swipe interface 10 further includes a plurality of secondary touch points 20 displayed on the screen. In the embodiment shown in FIG. 1, there are six secondary touch points 20 arranged across the bottom of the screen 12; however, in other embodiments the number of secondary touch points and/or their arrangement may be variable and selected by the user. For purposes of illustration, the secondary touch points in FIG. 1 are labeled 20j through 20o; however, these labels will not be displayed (i.e., on screen) in most implementations of the system. The secondary touch points 20 are distinguishable from one another by a non-location characteristic. For example, in the embodiment shown in FIG. 1, the secondary touch points 20 are all different colors (for purposes of illustration, the secondary touch points are lined for color in FIG. 1). In other embodiments, the secondary touch points may be different shapes (circle, square, triangle, etc.), different letters, different images (animals, symbols, etc). Preferably, the location and/or order of display of the secondary touch points 20 is randomly changed with each presentation of the finger swipe interface 10. In other words, secondary point 20j (black color) is in the left-most position in FIG. 1; however, it may be in the right-most position the next time the swipe pattern is shown.

It will be appreciated that the touch points 20 illustrated in FIG. 1 are only one form of secondary indicia that may be used in the invention. For the purposes of this application, a secondary indicia means any user-distinguishable characteristic, e.g., color, shape, size, letter, etc., that can be displayed in a discrete area of a display device, provided the characteristic is not location dependent. The secondary indicia are not location dependent because the positions of the secondary indicia may be intentionally randomly assigned to differing locations in each finger swipe cycle. The user must be able to distinguish the key secondary indicia from a plurality of non-key secondary indicia that are displayed in connection with each finger swipe cycle.

The key to the finger swipe interface 10 includes both a key pattern for the touch points 16 (e.g., g-e-c-f-i-e) and at least one key secondary touch point (e.g., 20j—black). The user must correctly enter both the matching swipe pattern (of touch points 16) and the matching secondary touch point 20 to be authorized to proceed. Although the visible path of the swipe pattern 18 may become visible, it will not be possible to determine the correct secondary touch point from visible marks on the screen because the location of the secondary points 20 are randomly rearranged on each presentation.

Adding a color selection choices (or other user selectable characteristics) for the secondary touch points and allowing the user to increase the number of touch points to swipe on the screen makes for a dynamic sequence that is more complex and secure while expediting conventional login processes that engage full alpha and or numeric keyboard strokes.

In another aspect of the invention, a system and method for using a finger swipe interface to control a system comprises the following steps:

### A. Sign-Up/Programming Phase:

1. A user enters “enrolls” personal information and account information, e.g., user ID and password
2. The user selects number and sequence of touch points for swipe pattern
3. The user teaches “key” swipe pattern to system.
4. The user selects “key” color.
5. The system learns frequented secured websites and then adopts login information into system which is secured by swipe pattern and color selection

### B. Normal Operation/Sign-in Phase (“Three-Strikes” Embodiment)

1. A swipe screen is displayed.
2. The user enters a 1st swipe code attempt.
3. A 1st color palette displayed with N colors.
   a. The colors of 1st palette may be chosen by algorithm based on number of touch points and specific swipe pattern of 1st swipe attempt.
   b. The 1st palette will include key color in offerings only if key swipe was entered.
4. If the key color is chosen, then access granted (using previously entered account information).
5. If the incorrect color is chosen, then the system returns to swipe screen (this path is always followed if incorrect swipe was entered, because key color is not included in palette).
6. The user enters 2nd swipe code attempt (within given time limit).
7. A 2nd color palette displayed with 2×N colors
   a. The colors of 2nd palette may be chosen by algorithm based on number of touch points and specific swipe pattern of 2nd swipe attempt.
   b. The 2nd palette will include key color in offerings only if key swipe was entered.
8. If the key color is chosen, then access granted (using previously entered account information).
9. If the incorrect color is chosen, then the system returns to swipe screen (this path is always followed if incorrect swipe was entered, because key color is not included in palette).
10. The user enters 3rd swipe code attempt (within given time limit).
11. A 3rd color palette displayed with 3×N or 4×N colors
   a. The colors of 3rd palette may be chosen by algorithm based on number of touch points and specific swipe pattern of 3rd swipe attempt.
   b. The 3rd palette will include key color in offerings only if key swipe was entered.
12. If the key color is chosen, then access granted (using previously entered account information).
13. If the incorrect color is chosen, then system enters “Lockdown” mode.

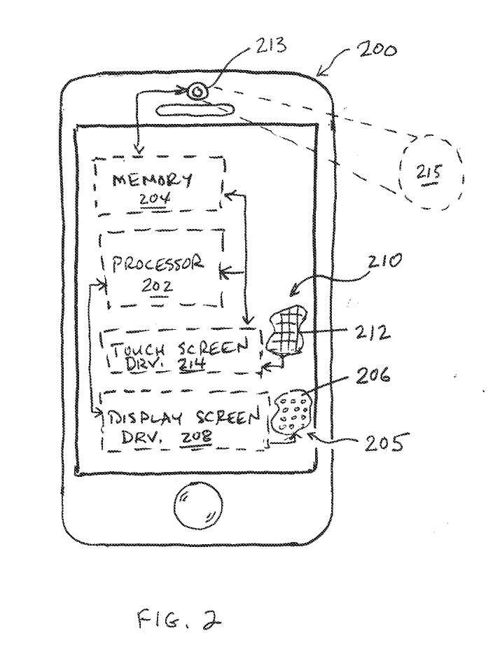

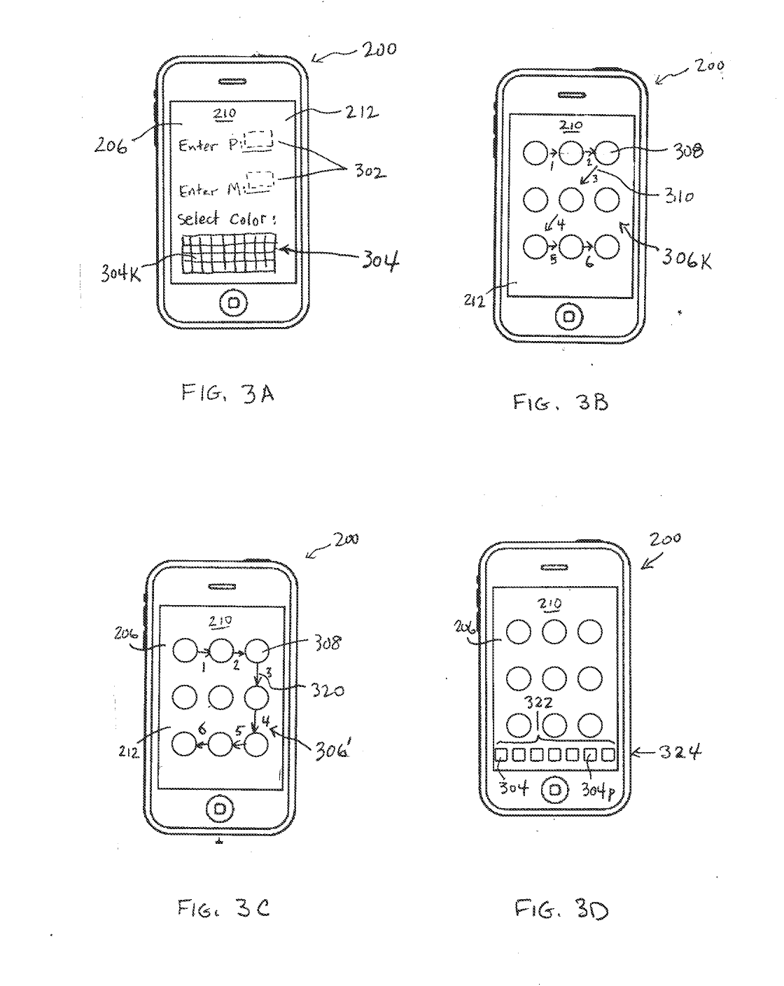

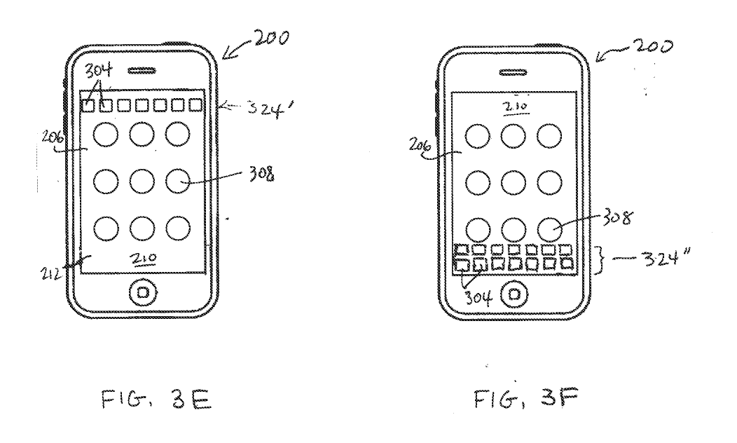

Referring now to FIGS. 2 to 3A-3F, there is illustrated a method executable on a computing device for using a finger swipe interface to control the functionality of a system implemented on the computing device, in accordance with another aspect of the invention.

Referring first to FIG. 2, a suitable computing device 200 may be a computer, smart phone, tablet computer, ATM (Automatic Teller Machine), POS (Point Of Sale) terminal or other computing device having the components described herein. The computing device 200 may include a processor 202, a memory 204 operatively connected to the processor and a display device 205 operatively connected to the processor. In the illustrated embodiment, the display device 205 is an integrated display screen 206 (only a portion is illustrated in FIG. 2) operatively connected to the processor 202 via a screen driver circuitry 208. In other embodiments, the display device 205 may be a separate screen, or even discrete buttons or lights that are physically separated from the computing device, but operatively connected to the processor 202 such that the display and sensing of secondary indicia may be accomplished as further described herein. The computing device 200 may further include a camera 213 operatively connected to the processor 202 and capable of sensing or detecting the movement of specified objects, e.g., human fingers, limbs (i.e., hands, arms, etc.), within a field of view 215.

Referring still to FIG. 2, a finger swipe interface 210 is operatively connected to the computing device 200 and capable of sensing an ordered sequence of M spatial movements performed by a specified object between a preselected set of P spatial points in proximity to the finger swipe interface. In the illustrated embodiment, the finger swipe interface 210 comprises an integrated touch screen 212 physically incorporated into the computing device 200 and operatively connected to the processor 202 via a touch screen driver circuitry 214. The touch screen 212 is capable of sensing or detecting in real time an ordered sequence of M spatial movements executed by a specified object, e.g., a human finger or touch screen stylus (not illustrated), between a preselected set of P spatial points (see FIG. 1) in proximity to the touch screen. In this case, the spatial points are predefined areas on the surface of the touch screen 212. The finger swipe pattern (or data indicative of the finger swipe pattern) sensed by the finger swipe interface 210 may be transferred using the processor 202 and stored in the memory 204.

In other embodiments, the finger swipe interface 210 may be physically separate from the computing device 200, but operatively connected to the processor 202 in the computing device such that the finger swipe pattern sensed by the finger swipe interface may be transmitted to the computing device using the processor 202 and stored in the memory 204. For example, the finger swipe interface 210 may comprise a touch pad (not illustrated) that is separate from the computing device but mounted close by (e.g., in the proximity of an ATM, POS terminal, etc.). In other cases, the finger swipe interface 210 may include a camera 213 or other non-contact sensing system operatively connected to the computing device 200 that is capable of sensing or detecting the movement of human fingers, limbs (e.g., hands, arms, etc.) or other specified objects moving within a field of view 215 or other sensing range. In such cases, the swipe pattern may comprise either a 2-D (i.e., two-dimensional) or 3-D (i.e., three-dimensional) pattern.

Referring now to FIGS. 3A-3F, methods executable on a computing device for using a finger swipe interface to control the functionality of a system are further described with reference to selected screens that would appear on the executing computing device 200.

Referring first to FIG. 3A, during an initial sign up process, values for the numbers of touch points P and ordered movements M to be used in a key swipe pattern, and a key secondary indicia must be stored in the memory 204 of the computing device 200. In some embodiments, the user may select the number of touch points P and movements M to be used in a key swipe pattern. For example, the values for the M and P parameters may be entered in appropriate fields 302 using the touch screen 212 or other input device, and then stored in the memory 204 via the processor 202. In other embodiments, the values for M and P may be predetermined or pre-loaded into the memory 204 of the computing device 200.

In most embodiments, the user may select one secondary indicia to be the key secondary indicia. The key secondary indicia is selected from a set of S available different secondary indicia. The individual secondary indicia within a set of available secondary indicia are distinguishable from one another by a non-location characteristic. For example, the secondary indicia may include, but are not limited to, sets of different colors, sets of different patterns, sets of different shapes (e.g., circle, square, triangle, etc.), sets of different alphabetic letters, sets of different images (emoticons, animals, symbols, etc). The secondary indicia may further reflect more than one non-location characteristic, for example, a set of differently colored different geometric shapes.

In the embodiment illustrated in FIG. 3A, the set of S available different secondary indicia is a set of S different colors 304 displayed on the touch screen 212. In this embodiment, the user may select a key secondary indicia by touching one of the colors (in this case, the key is designated 304k), among the plurality of displayed colors. The selected key secondary indicia 304k (or data indicative of the selected key secondary indicia) is stored in the memory 204 via the processor 202. In other embodiments, the key secondary indicia may be predetermined or pre-loaded into the memory 204 of the computing device 200.

Referring now to FIG. 3B, a finger swipe pattern 306 including a set of ordered movements executed between a set of spatial points is selected as a key finger swipe pattern. In some embodiments, a pattern of P spatial points 308 is first displayed on the finger swipe interface 210, and then the user executes M ordered movements (designated by arrows 310) between the spatial points in proximity to the finger swipe interface to define the key finger swipe pattern. In the illustrated embodiment, the ordered movements may be executed by moving a finger or stylus (not shown) across the touch screen 212. The movements between spatial points are sensed by the finger swipe interface 210 and information regarding the pattern may be transferred to the processor 202 for storage in the memory 204.

Referring still to FIG. 3B, the key finger swipe pattern (designated 306k) in the illustrated embodiment is a “Z-shaped” pattern that includes 6 ordered movements between 9 spatial points (it is not typically required that a finger swipe pattern utilize all available spatial points). The selected key finger swipe pattern 306k (or data indicative of the selected key secondary indicia) is stored in the memory 204 via the processor 202. In other embodiments, the key secondary indicia 306k may be predetermined or randomly selected by the system or predetermined by, e.g., administrative decision, and pre-loaded into the memory 204 of the computing device 200.

It will be appreciated that it is not necessary to designate the key finger swipe pattern 306k after the selection of the key secondary indicia 304k as in the example of FIGS. 3A and 3B. The selection of a key finger swipe pattern 306k, the selection of a key secondary indicia 304k, and the subsequent storage of the keys (or data indicative of the keys) in the memory 204 may be performed in any order.

Referring now to FIG. 3C, following the initial selection of a key finger swipe pattern 306k and a key secondary indicia 304k, further execution of the method allows another system implemented on the computing device 200 to be controlled using the finger swipe interface 210. A common type of system to be controlled using the method is a “sign on” screen system, user authorization system or other security-related system implemented on the computing device 200. Alternatively, other type of systems implemented on the computing device 200 may be controlled by the method.

FIG. 3C shows a screen implemented to control a “sign on” system. To initiate control of the controlled system, a finger swipe counter N is typically reset to N=1. A finger swipe interface 210 is then presented on the touch screen 212 including the appropriate number of spatial points 308 (also known as “touch points”). As previously indicated, the spatial points 308 may be visible or not visible, depending on the embodiment.

The user executes a first (i.e., N=1) finger swipe operation by executing in real time a set of ordered movements 320 between the set of spatial points 308 in proximity to the finger swipe interface 210 to designate a pick(N) swipe pattern 306 (designated 306′), in this case the pick(1) swipe pattern. The movements between spatial points 308 are sensed by the finger swipe interface 210 and information regarding the pick(1) swipe pattern 322 may be transferred to the processor 202 for storage in the memory 204. In the illustrated embodiment, the ordered movements 320 may be executed by moving a finger or stylus (not shown) across the touch screen 212.

Next, a comparison is made using the processor 202, of the pick(1) swipe pattern 306′ stored in the memory 204 to the key swipe pattern 306k stored in the memory. In this case, the pick(1) swipe pattern 306′ in the illustrated embodiment is a “reverse-C shaped” pattern that includes 6 ordered movements between 9 spatial points. Although the number of ordered steps is the same, the swipe pattern 306′ is not the key swipe pattern 306k. A “positive” swipe(N) result, in this case swipe(1) result, is stored in the system memory 204 if the pick(1) swipe pattern 306′ is the key swipe pattern 306k; and a “negative” swipe(1) result is stored in the memory if the pick(1) swipe pattern is not the key swipe pattern. In the illustrated example, a negative swipe(1) result is stored in the memory 204.

Referring now to FIG. 3D, the swipe(N) result, in this case swipe(1) is retrieved from the memory 204. An array(N) of S_{N} different secondary indicia is selected from the set of S available secondary indicia 304 (FIG. 3A) and is displayed on the display screen 206 at a plurality of discrete display locations 322. In this case, S₁=7, so an array(1) 324 of 7 different secondary indicia 304 is displayed at the discrete locations 322 of the display screen 206. Each secondary indicia 304 of the array(N) 324 of S_{N} secondary indicia is disposed in a different respective discrete display location, e.g., 322′, 322″, of the plurality of discrete display locations 322. The selection of which particular secondary indicia 304 of the array(N) is to be located in each respective discrete display location is performed using one of a random or pseudo-random selection. If a “positive” swipe(N) result is retrieved from the memory 204, the array(N) of S_{N} secondary indicia includes the key secondary indicia 304k and a set(N) of (S_{N}−1) different non-key secondary indicia 304 selected from the S available secondary indicia. If, however, a “negative” swipe(N) result is retrieved from the memory 204, the array(N) of S_{N} secondary indicia includes only a set(N) of S_{N} different non-key secondary indicia selected from the S available secondary indicia. Thus, the key secondary indicia 304k is not displayed when the swipe(N) result is “negative”. Thus, in the illustrated embodiment, since the pick(1) swipe pattern 306′ was not the key swipe pattern 306k, then the key secondary indicia 304k is not included in the set(1) of 7 secondary indicia 304 in array(1) 324. While a user knowing the correct value (e.g., color) of the key secondary indicia 304k may recognize that the key is not present in array(1), an unauthorized user will not, and thus it will be more difficult to determine whether the wrong swipe pattern was used or the wrong secondary indicia was selected. Accordingly, security against unauthorized users is improved.

Referring still to FIG. 3D, the user selects one of the displayed secondary indicia 304 as a pick(N) secondary indicia, designated 304p. The processor 202 senses the selection of the pick(N) secondary indicia, in this case pick(1) secondary indicia 304p selected in real time from the array(1) of 7 secondary indicia 304 displayed on the display device 206. The pick(N) secondary indicia 304p (or value thereof) is stored in the memory 204 of the computing device 200.

The processor then compares, the pick(N) secondary indicia 304p stored in the memory to the key secondary indicia 304k stored in the memory. The processor 202 controls the system implemented on the computing device 200 to function in a first manner if the pick(N) secondary indicia is the key secondary indicia; and controls the system to function in a second manner if the pick(N) secondary indicia is a non-key secondary indicia. In the illustrated example, the first manner of control of the implemented “sign-on” system may be to “approve” sign-on, whereas the second manner of control of the implemented system may be to “deny” sign-on. Since the pick(1) swipe pattern 306′ was not the key swipe pattern 306k, then the method controls the system to operate in a second manner, and the sign-on is denied (at least for attempt N=1).

Referring now to FIG. 3E, in some embodiments, if the just-completed finger swipe authentication attempt (e.g., FIGS. 3B, 3C and 3D) was unsuccessful (i.e., the key secondary indicia was not selected), then another finger swipe authentication attempt commences, provided, however, that a preselected number of attempts is not exceeded. Put another way, when the pick(N) secondary indicia is a non-key secondary indicia, then the method further comprises the following steps: incrementing the value of N to (N+1), provided N does not exceed a predetermined maximum value; and repeating the previously described post-initialization steps.

Referring still to FIG. 3E, in one such embodiment, in the next authentication attempt, the array(N) of secondary indicia 304 may be displayed in a different location from the previous attempt. Thus, if FIG. 3E represents the second attempt (i.e., N=2), then the array(2) 324′ may be located at the top of the display screen 206 rather than at the bottom, where array(1) 324 was. Further, since the S_{N} non-key secondary indicia included in the array(N) for each finger swipe cycle may be selected from the set of available secondary indicia using one of a random or pseudo-random selection, then the secondary indicia 304 of array(2) 324′ will likely contain at least some different secondary indicia compared to the previous array(1) 324, and the positions of the different secondary indicia 304 will be changed from the first attempt. In some embodiments, whether or not the key secondary indicia 304k is included in the array(2) 324′ depends on whether the second swipe pattern (not shown) matches the key swipe pattern.

Referring now to FIG. 3F, in still further embodiments, the number of secondary indicia 304 presented in each authentication attempt is larger than in the previous attempt. For example, in one preferred embodiment, the number of secondary indicia 304 in the array(N) is doubled in the second attempt, and tripled in the third attempt, e.g., where S_{N} is the number of secondary indicia displayed in the first authentication attempt, S_{(N+1)}=(2×S_{N}); and S_{(N+2)}=(3×S_{N}). In another preferred embodiment, the number of secondary indicia 304 in the array(N) is doubled in the second attempt, and doubled again (i.e., quadrupled) in the third attempt, e.g., where S_{N} is the number of secondary indicia displayed in the first authentication attempt, S_{(N+1)}=(2×S_{N}); and S_{(N+2)}=(4×S_{N}). In the illustrated embodiment, the number S₁ of secondary indicia 304 in the array(1) of the first attempt is 7, and the number S₂ of secondary indicia 304 in the second array, array(2) 324″ (pictured in FIG. 3F) is 14. Depending on the embodiment, the number S₃ of secondary indicia 304 in the third array, array(3) (not shown) may be either 21 or 28. In such embodiments, as in the embodiments previously described, whether or not the key secondary indicia 304k is included in the array(N) may depend on whether the pick(N) swipe pattern matched the key swipe pattern.

It will be appreciated by those skilled in the art having the benefit of this disclosure that this method and apparatus for using a finger swipe interface to control a system provides significant advantages over conventional finger swipe systems. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims.

Thus, it is intended that the following claims be interpreted to embrace all such further modifications, changes, rearrangements, substitutions, alternatives, design choices, and embodiments.

What is claimed is:

1. A method executable on a computing device for using a finger swipe interface to control the functionality of a system implemented on the computing device, the computing device including a processor, a memory operatively connected to the processor and a display device operatively connected to the processor, the finger swipe interface being operatively connected to the computing device and capable of sensing an ordered sequence of M spatial movements performed by a specified object between a preselected set of P spatial points in proximity to the finger swipe interface, the method comprising the following steps:
(a) storing, in a memory of a computing device, a key swipe pattern including a set of M_{K} ordered movements to be executed between a set of P_{K} spatial points;
(b) storing, in the memory of the computing device, a key secondary indicia, the key secondary indicia being selected from a set of S different available secondary indicia;
(c) initializing the finger swipe cycle by setting value N=1;
(d) sensing, using a finger swipe interface operatively connected to the computing device, a pick(N) swipe pattern including a set of M_{N} ordered movements executed in real time between a set of P_{N} spatial points by a specified object in proximity to the finger swipe interface;
(e) transferring the pick(N) swipe pattern from the finger swipe interface to the computing device and storing the pick(N) swipe pattern in the memory of the computing device using a processor operatively connected to the memory;
(f) displaying, on a display device operatively connected to the processor and having a plurality of discrete display locations, an array(N) of S_{N} different secondary indicia selected from the set of S available secondary indicia,
wherein each secondary indicia of the array(N) of S_{N} secondary indicia is disposed in a different respective discrete display location of the plurality of discrete display locations,
wherein the selection of which particular secondary indicia of the array(N) is to be located in each respective discrete display location is performed using one of a random or pseudo-random selection, and
wherein the array(N) of S_{N} secondary indicia includes
the key secondary indicia, and
a set(N) of (S_{N}−1) different non-key secondary indicia selected from the S available secondary indicia;
(g) sensing, using the processor, a pick(N) secondary indicia selected in real time from the array(N) of S_{N} secondary indicia displayed on the display device;
(h) storing the pick(N) secondary indicia in the memory of the computing device;
(i) comparing, using the processor, the pick(N) swipe pattern stored in the memory to the key swipe pattern stored in the memory;
(j) comparing, using the processor, the pick(N) secondary indicia stored in the memory to the key secondary indicia stored in the memory; and
(k) controlling, using the processor, a system implemented on the computing device to function in a first manner if both
the pick(N) swipe pattern is the key swipe pattern, and
the pick(N) secondary indicia is the key secondary indicia; and
(L) controlling, using the processor, the system implemented on the computing device to function in a second manner if either
the pick(N) swipe pattern is not the key swipe pattern, or
the pick(N) secondary indicia is a non-key secondary indicia.

2. A method in accordance with claim 1, wherein when either (i) the pick(N) swipe pattern is not the key swipe pattern, or (ii) the pick(N) secondary indicia is a non-key secondary indicia, then the method further comprises the following steps:
incrementing the value of N to (N+1), provided N does not exceed a predetermined maximum value; and
repeating steps (d)-(L).

3. A method in accordance with claim 2, wherein S_{N}=S, such that the key secondary indicia and all non-key secondary indicia are displayed in the array(N) of secondary indicia in each finger swipe cycle.

4. A method in accordance with claim 2, wherein S_{N}<S and the step of displaying an array(N) further comprises:
populating the array(N) with the key secondary indicia and (S−S_{N}−1) different non-key secondary indicia; and
wherein the non-key secondary indicia in the array(N) are selected from the set of available secondary indicia using one of a random or pseudo-random selection;
whereby a different selection of non-key secondary indicia is displayed in each finger swipe cycle.

5. A method in accordance with claim 4, wherein S_{N}<S_{(N+1)}<S_{(N+2)}, whereby the number of non-key secondary indicia displayed on the display device increases in successive finger swipe cycles.

6. A method in accordance with claim 2, wherein the array(N) of S_{N} secondary indicia is displayed in a different portion of the display device in successive finger swipe cycles.

7. A method in accordance with claim 1, wherein the step of storing a key swipe pattern further includes:
specifying, using the processor of the computing device, the value of M_{K} that is the number of ordered movements included in the key swipe pattern;
specifying, using the processor of the computing device, the value of P_{K} that is the number of spatial points included in the key swipe pattern; and
sensing in real time, using the finger swipe device operatively connected to the computing device, an ordered sequence of M_{K} movements between the P_{K} spatial points.

8. A method in accordance with claim 1, wherein the set of S different available secondary indicia includes at least one of:
a set of S different colors;
a set of S different geometric shapes; or
a set of S different alphabetic letters.

9. A method in accordance with claim 1, wherein the finger swipe interface includes a touch screen device operatively connected to the computing device and the specified object is one of a human finger and a screen stylus moving in contact with the touch screen device.

10. A method in accordance with claim 1, wherein the finger swipe interface includes a camera system operatively connected to the computing device and the specific object is one of a human finger or human limb moving non-contact spatial proximity to the camera.

11. A method executable on a computing device for using a finger swipe interface to control the functionality of a system implemented on the computing device, the computing device including a processor, a memory operatively connected to the processor and a display device operatively connected to the processor, the finger swipe interface being operatively connected to the computing device and capable of sensing an ordered sequence of M spatial movements performed by a specified object between a preselected set of P spatial points in proximity to the finger swipe interface, the method comprising the following steps:
(a) storing, in a memory of a computing device, a key swipe pattern including a set of M_{K} ordered movements to be executed between a set of P_{K} spatial points;
(b) storing, in the memory of the computing device, a key secondary indicia, the key secondary indicia being selected from a set of S different available secondary indicia;
(c) initializing the finger swipe cycle by setting value N=1;
(d) sensing, using a finger swipe interface operatively connected to the computing device, a pick(N) swipe pattern including a set of M_{N} ordered movements executed in real time between a set of P_{N} spatial points by a specified object in proximity to the finger swipe interface;
(e) transferring the pick(N) swipe pattern from the finger swipe interface to the computing device and storing the pick(N) swipe pattern in the memory of the computing device using a processor operatively connected to the memory;
(f) comparing, using the processor, the pick(N) swipe pattern stored in the memory to the key swipe pattern stored in the memory;
(g) storing, in the memory, a “positive” swipe(N) result if the pick(N) swipe pattern is the key swipe pattern and storing, in the memory, a “negative” swipe(N) result if the pick(N) swipe pattern is not the key swipe pattern;
(h) retrieving the swipe(N) result from the memory and displaying, on a display device operatively connected to the processor and having a plurality of discrete display locations, an array(N) of S_{N} different secondary indicia selected from the set of S available secondary indicia,
wherein each secondary indicia of the array(N) of S_{N} secondary indicia is disposed in a different respective discrete display location of the plurality of discrete display locations,
wherein the selection of which particular secondary indicia of the array(N) is to be located in each respective discrete display location is performed using one of a random or pseudo-random selection, and
wherein if the “positive” swipe(N) result is retrieved from the memory, the array(N) of S_{N} secondary indicia includes
the key secondary indicia, and
a set(N) of (S_{N}−1) different non-key secondary indicia selected from the S available secondary indicia, and
wherein if a “negative” swipe(N) result is retrieved from the memory, the array(N) of S_{N} secondary indicia includes
a set(N) of S_{N} different non-key secondary indicia selected from the S available secondary indicia;
(i) sensing, using the processor, a pick(N) secondary indicia selected in real time from the array(N) of S_{N} secondary indicia displayed on the display device;
(j) storing the pick(N) secondary indicia in the memory of the computing device;
(k) comparing, using the processor, the pick(N) secondary indicia stored in the memory to the key secondary indicia stored in the memory; and
(L) controlling, using the processor, a system implemented on the computing device to function in a first manner if the pick(N) secondary indicia is the key secondary indicia; and
(m) controlling, using the processor, the system implemented on the computing device to function in a second manner if the pick(N) secondary indicia is a non-key secondary indicia.

12. A method in accordance with claim 11, wherein when the pick(N) secondary indicia is a non-key secondary indicia, then the method further comprises the following steps:
incrementing the value of N to (N+1), provided N does not exceed a predetermined maximum value; and
repeating steps (d)-(m).

13. A method in accordance with claim 12, wherein:
S_{N}<S and the non-key secondary indicia included in the array(N) for each finger swipe cycle are selected from the set of available secondary indicia using one of a random or pseudo-random selection;
whereby a different selection of non-key secondary indicia is displayed in each finger swipe cycle.

14. A method in accordance with claim 13, wherein S_{N}<S_{(N+1)}<S_{(N+2)}, whereby the number of non-key secondary indicia displayed on the display device increases in successive finger swipe cycles.

15. A method in accordance with claim 14, wherein:
S_{(N+1)}=(2×S_{N}); and
S_{(N+2)}=(3×S_{N}).

16. A method in accordance with claim 12, further comprising the steps of controlling, using the processor, when the maximum predetermined value for N is exceeded, a system implemented on the computing device to function in a “lockdown” mode.

17. A computing device for controlling the functionality of a system implemented on the computing device using a finger swipe interface, comprising:
a processor;
a memory operatively connected to the processor;
a display device operatively connected to the processor;
a finger swipe interface operatively connected to the processor and capable of sensing an ordered sequence of M spatial movements performed by a specified object between a preselected set of P spatial points in proximity to the finger swipe interface;
executable code stored in the memory of the computing device for storing, in the memory of the computing device, a key swipe pattern including a set of M_{K} ordered movements to be executed between a set of P_{K} spatial points;
executable code stored in the memory of the computing device for storing, in the memory of the computing device, a key secondary indicia, the key secondary indicia being selected from a set of S different available secondary indicia;
executable code stored in the memory of the computing device for initializing the finger swipe cycle by setting value N=1;
executable code stored in the memory of the computing device for sensing, using the finger swipe interface operatively connected to the computing device, a pick(N) swipe pattern including a set of M_{N} ordered movements executed in real time between a set of P_{N} spatial points by a specified object in proximity to the finger swipe interface;
executable code stored in the memory of the computing device for transferring the pick(N) swipe pattern from the finger swipe interface to the computing device and storing the pick(N) swipe pattern in the memory of the computing device using the processor;
executable code stored in the memory of the computing device for comparing, using the processor, the pick(N) swipe pattern stored in the memory to the key swipe pattern stored in the memory;
executable code stored in the memory of the computing device for storing, in the memory, a “positive” swipe(N) result if the pick(N) swipe pattern is the key swipe pattern and storing, in the memory, a “negative” swipe(N) result if the pick(N) swipe pattern is not the key swipe pattern;
executable code stored in the memory of the computing device for retrieving the swipe(N) result from the memory and displaying, on a display device operatively connected to the processor and having a plurality of discrete display locations, an array(N) of S_{N} different secondary indicia selected from the set of S available secondary indicia,
wherein each secondary indicia of the array(N) of S_{N} secondary indicia is disposed in a different respective discrete display location of the plurality of discrete display locations,
wherein the selection of which particular secondary indicia of the array(N) is to be located in each respective discrete display location is performed using one of a random or pseudo-random selection, and
wherein if the “positive” swipe(N) result is retrieved from the memory, the array(N) of S_{N} secondary indicia includes
the key secondary indicia, and
a set(N) of (S_{N}−1) different non-key secondary indicia selected from the S available secondary indicia, and
wherein if a “negative” swipe(N) result is retrieved from the memory, the array(N) of S_{N} secondary indicia includes
a set(N) of S_{N} different non-key secondary indicia selected from the S available secondary indicia;
executable code stored in the memory of the computing device for sensing, using the processor, a pick(N) secondary indicia selected in real time from the array(N) of S_{N} secondary indicia displayed on the display device;
executable code stored in the memory of the computing device for storing the pick(N) secondary indicia in the memory of the computing device;
executable code stored in the memory of the computing device for comparing, using the processor, the pick(N) secondary indicia stored in the memory to the key secondary indicia stored in the memory; and
executable code stored in the memory of the computing device for controlling, using the processor, a system implemented on the computing device to function in a first manner if the pick(N) secondary indicia is the key secondary indicia; and
executable code stored in the memory of the computing device for controlling, using the processor, the system implemented on the computing device to function in a second manner if the pick(N) secondary indicia is a non-key secondary indicia.

18. A computing device in accordance with claim 17, wherein the finger swipe interface includes a touch screen device operatively connected to the processor and the display device is a display screen operatively connected to the processor.

19. A computing device in accordance with claim 18, wherein the secondary indicia are at least one of:
a set of S different colored areas on the display screen;
a set of S different geometric shapes on the display screen; or
a set of S different alphabetic letters on the display screen.

20. A method in accordance with claim 1, wherein the finger swipe interface includes a camera system operatively connected to the computing device and the specific object is one of a human finger or human limb moving non-contact spatial proximity to the camera.
